(19) United States
(12) Patent Application Publication
(10) Pub. No.: US 2026/0162173 A1
(43) Pub. Date: Jun. 11, 2026

(54) Revolver

(71) Applicant: Vincent Grupi, Davie, FL (US)

(72) Inventor: Vincent Grupi, Davie, FL (US)

(21) Appl. No.: 15/932,425

(22) Filed: Apr. 25, 2016

(51) Int. Cl. G06Q 30/08; G06Q 20/02; G06Q 20/38

(52) U.S. Cl. CPC G06Q 30/08; G06Q 20/02; G06Q 20/384

(57) ABSTRACT

A novel auction method and application, Revolver utilizes the hub and satellite design, enabling unlimited scaling. The hub user invites satellite users to internet events by sharing the URL. Invitees download the free Revolver application. Everyone sharing the URL on Revolver application views the internet event and can chat.

For example, a hub social group sends an auction event URL to other satellite groups. Groups publish the URL and members download the free Revolver application or join hub group. Lots are published at satellite groups for viewing only. The hub group is at a trade show or other destination. A show booth projects the hub group/auction URL as live feed, attracting buyers and sellers. The hub group accepts chat bids for lots until sold or sells time slots to users.

Visited URL's are automatically saved by the Revolver application. Recalling them utilizes the novel dashboard Fractal Dropdowns. Because fractals descend in scale, many more visited URL's are displayed using the same screen space.

### FIELD OF THE INVENTION

The present invention relates generally to auction systems and methods, and more particularly relates to a real-time, simultaneously live and online auction session facilitated via a social networking website and conducted for members of at least one pre-established social networking group associated with the social networking website.

### BACKGROUND OF THE INVENTION

It is well-known that both buyers and sellers in an auction environment regard safe, trusted trading as being a paramount consideration for engaging in an auction transaction, particularly an online auction transaction. Unfortunately, many preexisting online auctions are not regarded as safe, trusted trading platforms. Additionally, most live and online auctions provide a preview period just prior to the beginning of the bidding period, where potential bidders are provided with a substantial amount of time (e.g., 2 hours) to preview auction items. During the preview period, there is a typical problem of bidding cabals forming, which results in unfair bidding practices. Therefore, a need exists to overcome the problems with the prior art as discussed above.

### DETAILED DESCRIPTION

Although the invention is illustrated and described herein as embodied in an auction system and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention. Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures. The figures of the drawings are not drawn to scale. Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. The present invention provides a novel and efficient system and method for conducting a simultaneous live and online auction session via a social networking platform and utilizing preexisting social networking groups as a trusted group for the auction session. The following description, with reference to FIGS. 1 through 4, shows several advantageous features of the present invention, but as will be described below, the invention can provide several shapes, sizes, combinations of features and components, and varying numbers and functions of the components.

The first example of a method of conducting a real-time, dual-mode auction may begin, in step 100, by inviting a third-party pre-established social networking group (e.g., a Facebook group) to participate in an auction session. The third-party pre-established social networking group is a trusted group, where members typically share an amount of trust with each other. The inventive method of the present invention leverages this trust and utilizes common shared interests among group members to conduct safe, trusted auction sessions. As used herein, the term “dual mode” IS intended to indicate an auction session that is simultaneously conducted in a live physical real-world venue and in an online environment via an Internet website. FIG. 2 illustrates an exemplary real-world venue environment where auctioned items may be projected onto a wall at the venue location during the simultaneously conducted online auction conducted via a social networking website (e.g., Facebook). In one embodiment, the auction session may be divided into a plurality of seller time slots. In another embodiment, each of the plurality of seller time slots has a predetermined beginning point and a predetermined ending point (e.g., 2 minutes). In one embodiment, the auction session may be, for example, 3 hours long having ninety 2-minute seller time slots, during which bidders may bid on a corresponding seller item. In one embodiment, the seller time slots are purchased by sellers at a predetermined price to monetize the method. An auction session can be any amount of time but IS preferably a few hours in length. In yet another embodiment, the time slots are determined by a number system, similar to a deli number system. In other words, the time slots can be formed as a queue system where numbers associated with a time slot are called and if the seller associated with said number is not present, the next time slot in the queue is called. In this embodiment, the time slots may not have predetermined beginnings or endings.

In step 102, the method includes receiving an acceptance of the invitation (FIG. 4) from the third-party pre-established social networking group. The invitation and the acceptance may be communicated between the inviting entity and the social networking group administrator by any means of communication, such as, for example, email, messaging, or other types of two-way communication technologies.

In step 104, an auction session is conducted as a live event at a physical, real-world venue location. In one embodiment, the live auction can be a jewelry and watch show auction in which members of a membership only group may bid on items in the physical real-world at the venue location. In a further embodiment, the social networking group may be a group associated with the type of auction, such as, a social networking group that focuses on jewelry and watch designs. In one embodiment, the auction session at the physical venue location is recorded in real-time. In another embodiment, at least a portion of the recording may be posted, displayed, or streamed via a social networking website (e.g., Facebook) associated with the pre-established social networking group. In a preferred embodiment, the recording is posted, displayed, or streamed via the social networking website during the live auction event. In one embodiment, the recording is a video recording. In another embodiment, the recording is an audio only recording. In yet another embodiment, the recording is a still image recording, i.e., a photograph. In a further embodiment, the photograph is preferably captured and posted on the social networking website during the auction session. In one embodiment, the recordings may be captured by body-cam coupled to personnel at the live venue location and/or video crew at the live venue location.

In step 106, simultaneously with the live auction event, the auction session is also conducted as an online auction event via the social networking website associated with the pre-established social networking group, as at least partially depicted in FIG. 2. Advantageously, the present invention blends both live and virtual auctions together in a novel format, while leveraging pre-established trust relationships often present in social networking groups.

In step 108, for each of the plurality of items to be sold during the plurality of seller time slots, publishing a visual representation of the item without a preview and substantially proximate in time to the beginning of the corresponding seller time slot. Advantageously, publishing the auction item without a preview eliminates the problem of bidding cabals. Most current auctions spend time preparing a preview; however, the preview allows bidders to make bidding arrangements. The inventive method eliminates this problem by publishing the auction item just prior to the corresponding seller time slot and without a preview period. In one embodiment, the visual representation can be a photograph. In another embodiment, the visual representation can be a video clip. In yet other embodiments, the visual representation may be displayed with or without a corresponding written description. In one embodiment, the publishing is performed by projecting a photograph of the item onto a wall at the live event venue location. In another embodiment, the publishing is performed by posting a visual representation (e.g., photograph) of the item on the social networking website just prior to the corresponding seller time slot. In one embodiment, at the live event venue location, the sellers are gathered to have their items photographed. Said photographs are then published on the social networking website, which website page is then projected onto a wall or projection screen at the live auction venue location, as depicted in FIG. 2. As used herein, the term “substantially proximate in time” can indicate a period of less than 5 minutes. In one embodiment, the term “substantially proximate in time” can indicate a period of 1-2 minutes, or even less than 1 minute prior to the beginning of the seller's time slot.

In step 110, for each of the plurality of time slots, receiving, during the time slot, bids on the corresponding item from members of the third-party pre-established social networking group via the social networking website. Group members can comment on the item and/or bid on the item through the social networking website, which is simultaneously displayed at the live event venue location (see FIG. 2). Accordingly, live auction bidders at the physical venue location can view the social networking website comments and/or bids submitted through the social networking website, as it displayed on the wall at the venue location. This dual-mode auction experience inventively blends live bids with virtual bids within the ecosystem of social networking websites. In one embodiment, when the live auction announcer hammers an item as sold, the same is also typed and posted on the social networking website group page so that virtual participants may follow the auction session. In a further embodiment, as the announcer begins describing the next item to be auctioned during the next time slot, the announcer's words may be posted on the group page and a photograph of the item may be simultaneously captured and then posted on the group page, as well, in real-time as the live auction session proceeds. In one embodiment, steps 108 and 110 are repeated for each item or lot until all the allotted time slots have been completed. In one embodiment, there may be a period dedicated to the presentation of any unsold items in order to give bidders at second chance a bidding on those unsold items. In one embodiment, payment of items may be submitted and processed through the social networking website. In yet another embodiment, the invitation (FIG. 4) may be sent to more than one third-party pre-established social networking group. In another embodiment, the invitations (FIG. 4) may be sent to overlapping social groups (FIG. 3).

### Software Unique Characteristics First Virtual Network Connection between iPhone and iPad.

First chat aggregator using Really Simple Syndication.

First cross platform remote control for streaming with iPhone.

First fractal dynamic screen display for storing favorites.

### Architecture

Virtual Network Connection: First the program (FIG. 5) searches and displays available IP addresses for connecting. Using an open port (I.E., 25) the iPhone and iPad can be selected enabling the phone to be mirrored on the pad, creating wireless remote control.

Chat aggregator: Revolver is a hub platform with other platforms as satellites (FIG. 3). Revolver can split the screen into three feeds (FIG. 7). The top feed is for a video platform or group platform (I.E. Facebook group), the bottom feed is the chat platform of user choice (I.E., different Facebook group) and the middle feed is the aggregate chat window. The software connects via Really Simple Syndication all chat platforms (I.E. Facebook groups) that select a common video platform (I.E. URL). By time stamping each incoming comment from different platforms, they can be served in chronological order in the aggregate window. The chat feature may be switched on and off. There is a whitelist and blacklist for chat usernames.

Remote Control: Revolver can store usernames and passwords for any platform and sub-platform designated a favorite (FIG. 6).

Fractal Screen: User screen contains favorite platforms saved (FIG. 6). Favorites are designated by color of importance and then relegated to that portion of the screen mapped for that color. The mapping is divided into rings: the center for search platforms (I.E. Google), the next ring for favorites, the last ring for everything else. The corners of the screen are mapped for chat platforms. The favorites are touch sensitive and will display sub-favorites as fly overs. User selects dynamic fractal pattern of choice from list of options.

### Usage Sequence

1 User receives Internet invitation (FIG. 4) to join event.
2 User downloads Revolver (FIG. 5) in app. store.
3 User opens app. and inputs event URL and chat group of choice.
4 Three windows open, top for video or event platform, bottom for chat platform of choice and third middle window for chat mixer (FIG. 7).
5 User may comment from their chat page and comments from everyone choosing same event URL will publish by time stamp in the Revolver chat mixer.

### Alternate Usage Sequence

1 User downloads Revolver (FIG. 5) application in app. store.
2 User selects search engine (I.E. Google, Bing, etc.) and locates a video platform for viewing that requires username and password which Revolver captures.
3 User saves platform in favorites (FIG. 6) which are mapped by color, light, medium and dark. Light is for favorites center screen, medium and dark for subsequent rings on screen.

Later, user returns to open Revolver (FIG. 5), and selects a previously saved favorite for video streaming.

### DRAWINGS DESCRIPTION

FIG. 1: The 6 possible steps of Revolver auction.

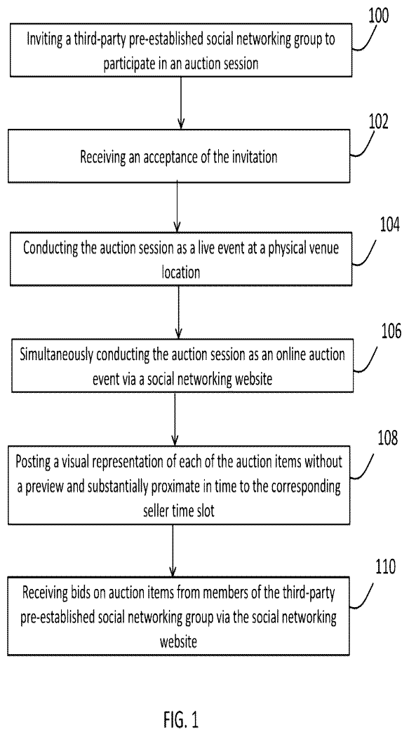

FIG. 2: Revolver booth at trade show.

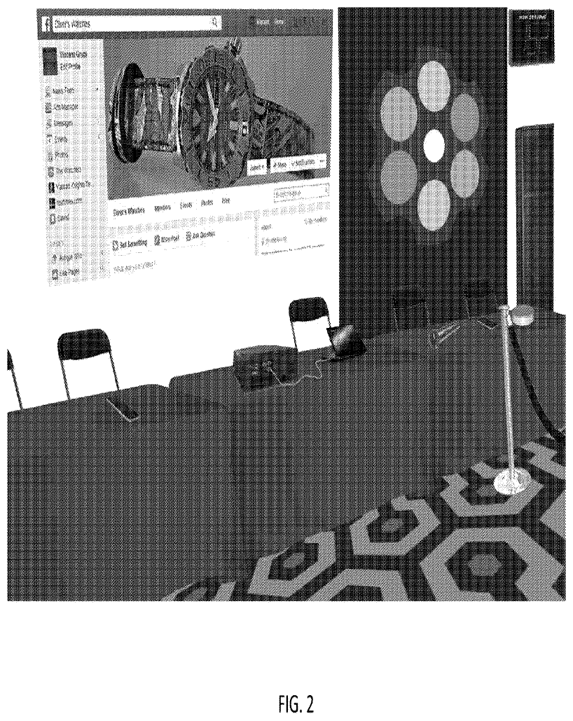

FIG. 3: Revolver hub and satellite information mixing configuration.

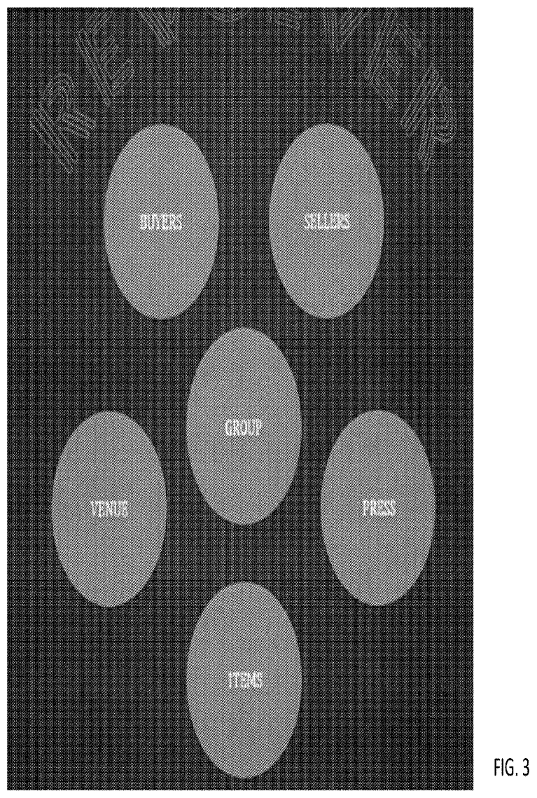

FIG. 4: Revolver auction invitation with method synopsis.

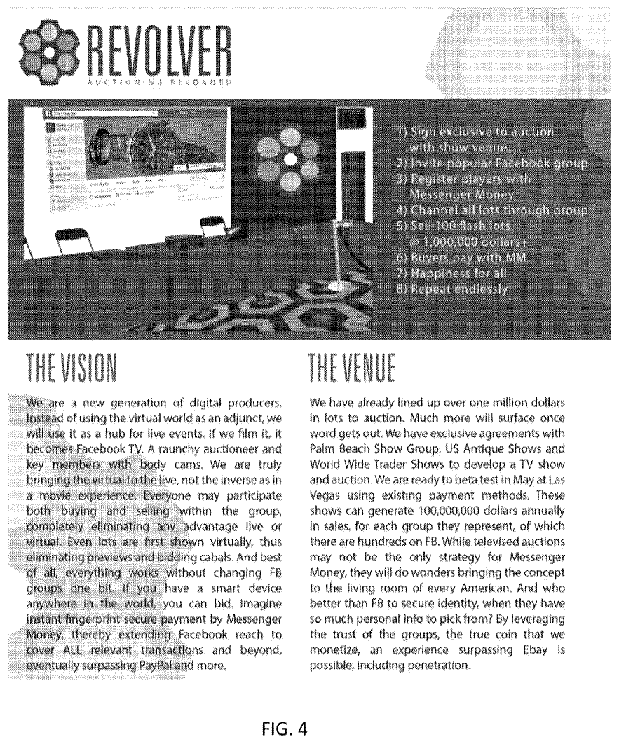

FIG. 5: Revolver launch button on iPhone screen.

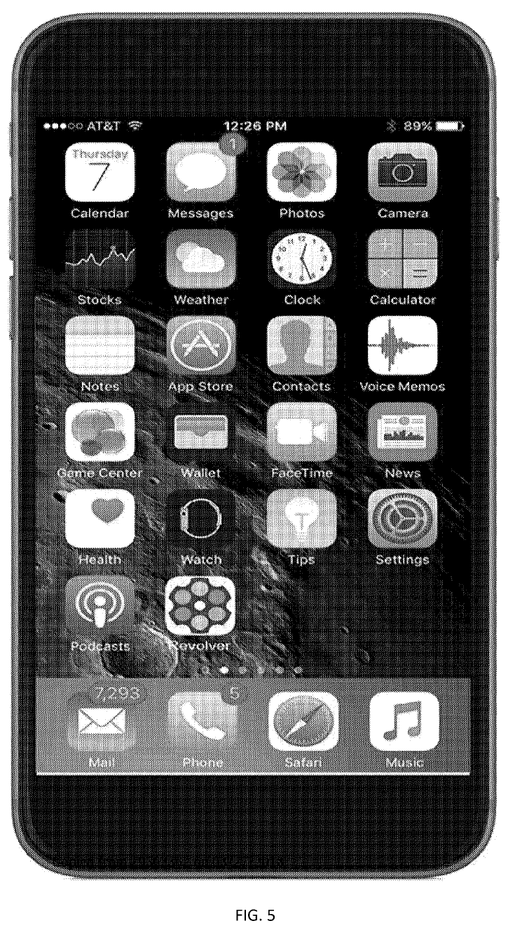

FIG. 6: Revolver fractal home screen with saved sites.

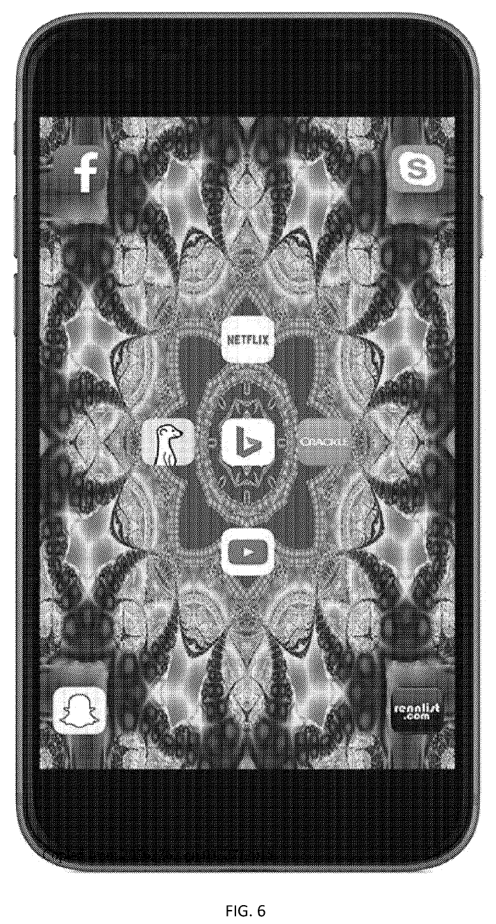

FIG. 7: Revolver iPhone split screen with shared event top and chat mixer bottom.

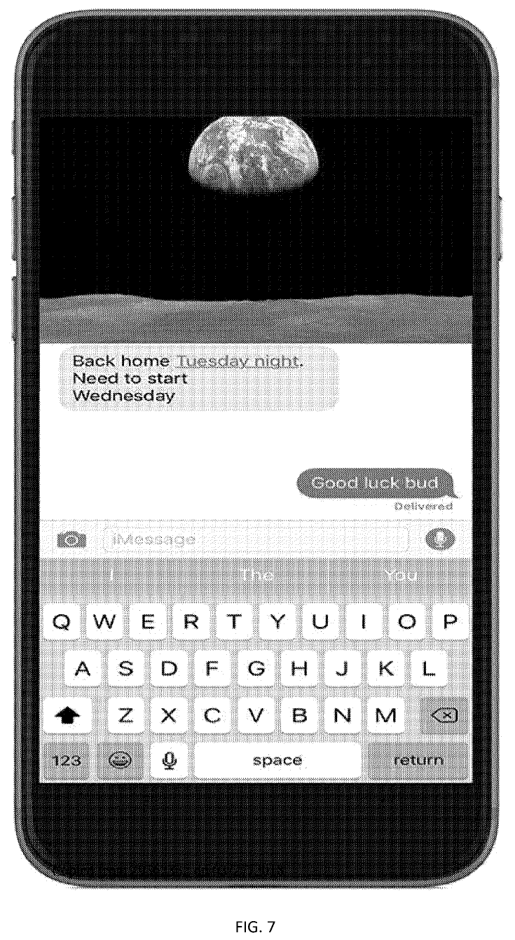

What is claimed is:

1. A method of conducting a real-time, dual-mode auction comprising:
inviting a third-party pre-established social networking group to participate in an auction session, the auction session divided into a plurality of seller time slots;
receiving an acceptance of said invitation from the third-party pre-established social networking group;
conducting the auction session as a live event at a physical venue location, the auction session at the physical venue location recorded in real-time;
simultaneously conducting the auction session as an online auction event via a social networking website associated with the pre-established social networking group;
for each of the plurality of items to be sold during the plurality of seller time slots, publishing a visual representation of the item without a preview and substantially proximate in time to the beginning of the corresponding seller time slot; and
for each of the plurality of time slots, receiving, during the time slot, bids on the corresponding item from members of the third-party pre-established social networking group via the social networking website.
